(19) United States
(12) Patent Application Publication
(10) Pub. No.: US 2021/0323667 A1
(43) Pub. Date: Oct. 21, 2021

(54) SYSTEMS AND METHODS FOR AUTOMATIC UNMANNED AERIAL VEHICLE OPERATIONS

(71) Applicant: AR2E LLC, Cherry Hill, NJ (US)

(72) Inventor: Ryan Archer, Tuckerton, NJ (US)

(21) Appl. No.: 17/232,297

(22) Filed: Apr. 16, 2021

Related U.S. Application Data
(60) Provisional application No. 63/010,773, filed on Apr. 16, 2020.

(51) Int. Cl. B64C 39/02; G05D 1/10; G05D 1/04

(52) U.S. Cl. CPC B64C 39/024; B64C 2201/146; G05D 1/042; G05D 1/101

(57) ABSTRACT

A fixed-wing UAV includes an automatically loitering routine to allow a single user to launch the vehicle. In a takeoff mode, the UAV follows a predefined routine to climb to a predetermined altitude and maintain a substantially constant distance from a controller. Once control inputs are received from the controller, the automatically loitering routine disengages. During a landing sequence, the UAV is placed into an autonomous landing mode. The UAV initiates a glide path to a desired landing position; at a predetermined altitude, the UAV executes a reverse thrust operation to quickly decelerate at a touch down point. The UAV then executes landing maneuvers to safely touch down.

### PRIORITY

The present application claims the benefit under 35 U.S.C. § 119(e) of U.S. Provisional App. No. 63/010,773 (filed Apr. 16, 2020), which is incorporated herein by reference.

### FIELD OF THE INVENTION

Embodiments of the inventive concepts disclosed herein are directed generally toward unmanned aerial vehicles.

### BACKGROUND

Traditionally, fixed-wing unmanned aerial vehicles (UAVs) are launched by a pair of operators with one operator initiating a startup sequence and a second operator hand launching the UAV. Alternatively, a single operator may initiate the startup sequence, place the controller down, and then hand launch the UAV without the controls in hand.

During landing, the operator directs the UAV to a landing area with sufficient clearance, and then brings the UAV to a final approach at speed. The operator may manually attempt to reduce aircraft speed at some point near the ground, but the final approach often ends by affectively crashing the UAV as gently as possible.

It would be advantageous if systems and methods existed to allow for a single operator to launch a fixed-wing UAV and land the UAV in a short approach landing area.

### SUMMARY

In one aspect, embodiments of the inventive concepts disclosed herein are directed to a fixed-wing UAV with an automatically loitering routine to allow a single user to launch the vehicle. In a takeoff mode, the UAV follows a predefined routine to climb to a predetermined altitude and maintain a substantially constant distance from a controller. Once control inputs are received from the controller, the automatically loitering routine disengages.

In a further aspect, during a landing sequence, the UAV is placed into an autonomous landing mode. The UAV initiates a glide path to a desired landing position; at a predetermined altitude, the UAV executes a reverse thrust operation to quickly decelerate at a touch down point. The UAV then executes landing maneuvers to safely touch down.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1 shows a perspective view of an unmanned aerial vehicle according to an exemplary embodiment of the present disclosure;

FIG. 2 shows a side view of an unmanned aerial vehicle according an exemplary embodiment of the present disclosure;

FIG. 3 shows a side view of an unmanned aerial vehicle according an exemplary embodiment of the present disclosure;

FIG. 4 shows a block diagram of a system suitable for implementing embodiments of the present disclosure;

FIG. 5 shows a block environmental view illustrating a process for automatic takeoff according to an exemplary embodiment of the present disclosure;

FIG. 6 shows a flowchart of a method for automatic takeoff according to an exemplary embodiment of the present disclosure;

FIG. 7 shows a block environmental view illustrating a process for automatic landing according to an exemplary embodiment of the present disclosure;

FIG. 8 shows a flowchart of a method for automatic takeoff according to an exemplary embodiment of the present disclosure;

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein are directed to an unmanned aerial vehicle (UAV) fuselage, wing and propeller design, and systems and methods for automatic landing and takeoff of a UAV.

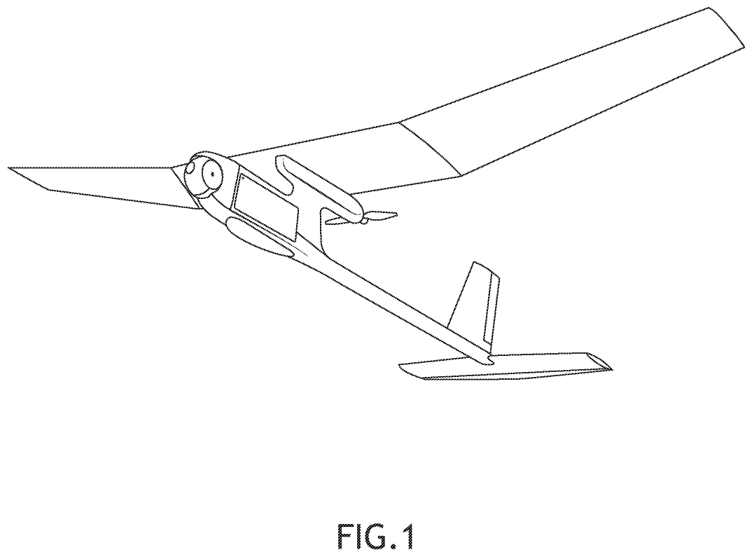

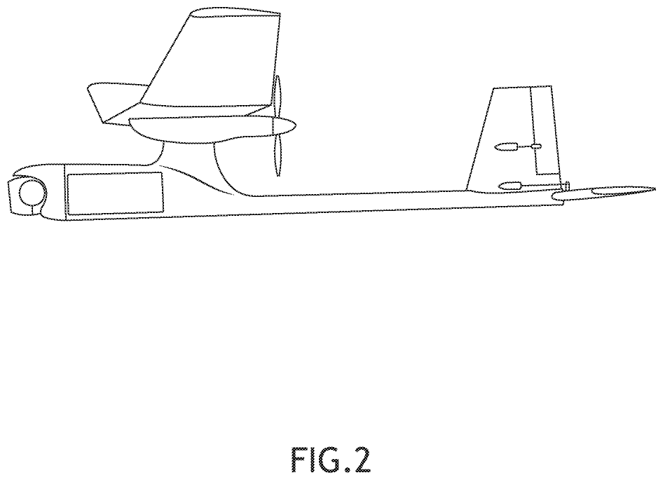

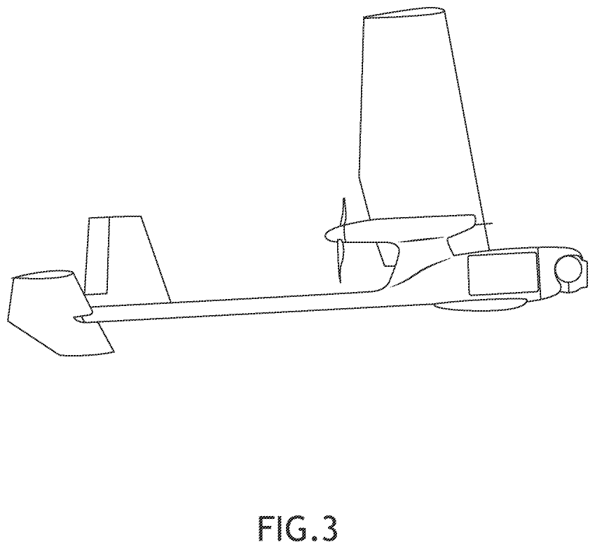

Referring to FIGS. 1-3, perspective and side views of an UAV according to exemplary embodiment of the present disclosure are shown. In at least one embodiment, a motor is disposed above the fuselage of the UAV on a pylon. The UAV wing is disposed on a top surface of the motor housing or the pylon including the motor housing. Furthermore, the motor housing may extend posteriorly or anteriorly to create a gap between the propeller and a trailing or leading surface of the wing. Air flow over the fuselage may be turbulent; raising the motor above the fuselage on a pylon creates separation from that turbulent air. Alternatively, the motor may be disposed within the fuselage of the UAV, and a power transmission element may drive a separate propeller disposed on the pylon. In such embodiments, the UAV wing may be disposed on the pylon and there may or may not be a defined housing for a propeller shaft.

Likewise, air flow over the central portion of the wing above the fuselage may also be turbulent; raising the combined motor housing and connected wing on the pylon, and creating a gap between the propeller and the corresponding edge of the wing, may also reduce propeller engagement of turbulent air. The gap may be defined by a threshold level of turbulence during normal flight, takeoff, landing, etc. The gap may be a function of the length of the wing (from anterior to posterior edges), airspeed of the UAV, shape of the fuselage, etc.; furthermore, characteristics of the propeller to operate within turbulent air may alter the size of the gap. In one exemplary embodiment, the gap may be on the order of ten centimeters. The wing connection to the fuselage, the shape of the fuselage, and the location of the propeller in relation to the fuselage and wing increase performance and/or reduce noise due to a reduced pressure differential because of the gap between the propeller and the edge of the wing.

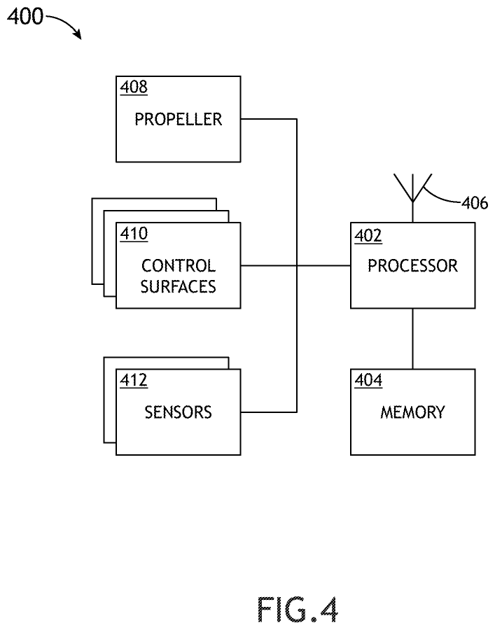

Referring to FIG. 4, a block diagram of a system 400 suitable for implementing embodiments of the present disclosure is shown. The system 400, embodied in a UAV, comprises a processor 402 and memory 404 for storing processor executable code to configure the processor 402 to actuate a propeller 408 and a plurality of control surfaces 410. In at least one embodiment, the processor 402 is in data communication with a wireless communication element 406 for sending and receiving data to and from a remote-control device. In at least one embodiment, the processor 402 is in data communication with one or more sensors 412 useful for implementing processes as more fully described herein.

The processor 402 may be configured to execute an? automatic takeoff process and/or an automatic landing process. Sensors 412 for executing such processes may include airspeed sensors, sonic or ultrasonic distance sensors, cameras, inertial sensors, lidar, barometer, etc. Furthermore, the wireless communication element 406 may include a GPS antenna. In at least one embodiment, the processor 402, sensors 412, and control surfaces 410 comprise a closed-loop system for controlling the UAV via sensor feedback and defined control algorithms.

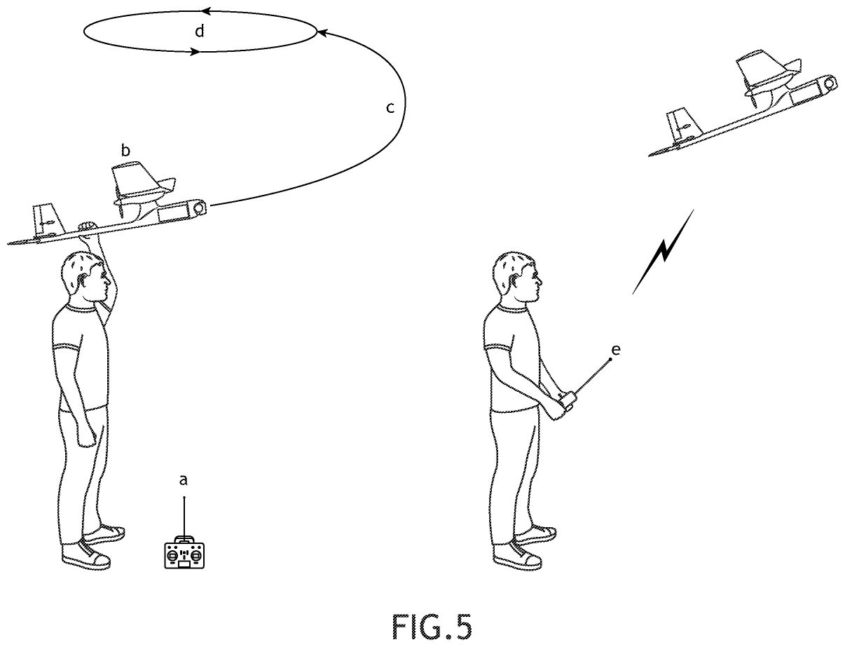

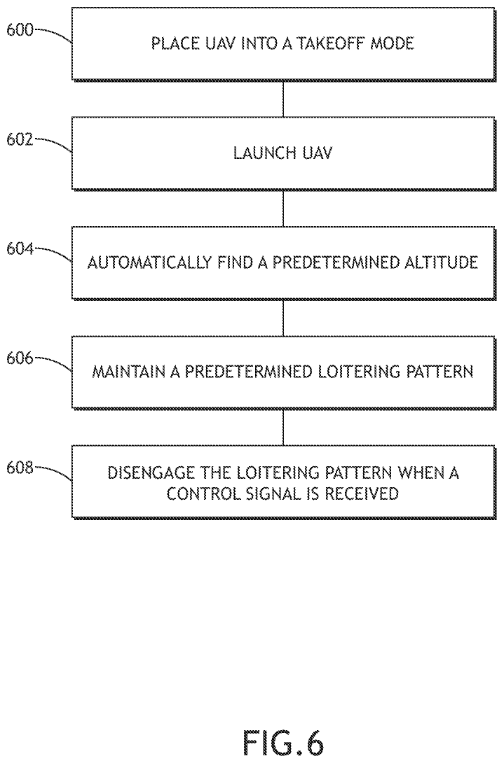

Referring to FIGS. 5 and 6, a block environmental view illustrating a process for automatic takeoff according to an exemplary embodiment of the present disclosure, and a corresponding flowchart, are shown. State of the art hand launched Class 1 and Class 2 UAVs require a crew of two or more to operate. One or more operators hand-launch the UAV and one or more operators man the UAV ground control station to control the aircraft after it is launched.

In at least one embodiment, a single UAV operator places 600 the UAV into a launch or takeoff mode. In at least one embodiment, the launch mode may be initiated via a specific signal from a ground control station; alternatively, the launch mode may be initiated automatically (locally to the UAV) if the UAV fails to establish a datalink connection to the ground control station for a predetermined period time after startup. The single operator may then throw the UAV to launch 602. In at least one embodiment, the UAV may determine it has launched via an onboard inertial sensor or GPS data. The UAV automatically finds 604 a predetermined altitude, for example via a change in height as determined by lidar, a barometer, an onboard GPS device, a distance sensor disposed in the fuselage to measure a distance from the ground, an algorithm for determining a distance from a ground control station controller, etc. In an exemplary embodiment, lidar may be used to determine altitude below fifty feet (15.24 meters), a barometer above fifty (15.24 meters) feet, and GPS altitude as a backup mechanism. Alternatively, or in addition, an onboard processor may put an onboard camera into an automatic launch configuration to determine the altitude of the UAV via object recognition and changes over time.

Upon finding 604 the predetermined altitude, the UAV maintains 606 a predetermined loiter pattern via manipulation of control surfaces. In at least one embodiment, the UAV may be configured to circle overhead, for example by maintaining the predetermined altitude and a predetermined distance from the ground control station controller, or by executing a predetermined set of control surface inputs with periodic corrections. Alternatively, or in addition, onboard sensors may be used to maintain and/or periodically correct the location of the UAV based on a “home” point established via GPS when the UAV is turned on. In at least one embodiment, an onboard camera in an automatic launch configuration may maintain 606 the loiter pattern via object recognition along the ground. When a control signal or a disengage signal is received from the ground control station, the UAV disengages 608 the process to maintain the loitering pattern.

In one exemplary embodiment, the operator places 600 the UAV into a launch mode via the ground control station, places the ground control station controller on the ground, and picks up the UAV for launch 602. When the operator launches 602 the UAV, the autopilot automatically climbs 604 to a pre-programmed altitude and starts 606 a pre-programmed loitering pattern comprising circling over the operator's head awaiting input from the ground control station. The operator may then pick up the ground control station controller and begin sending control commands to the UAV. Using this automatic launch and loiter capability the UAV may be operated by a single operator.

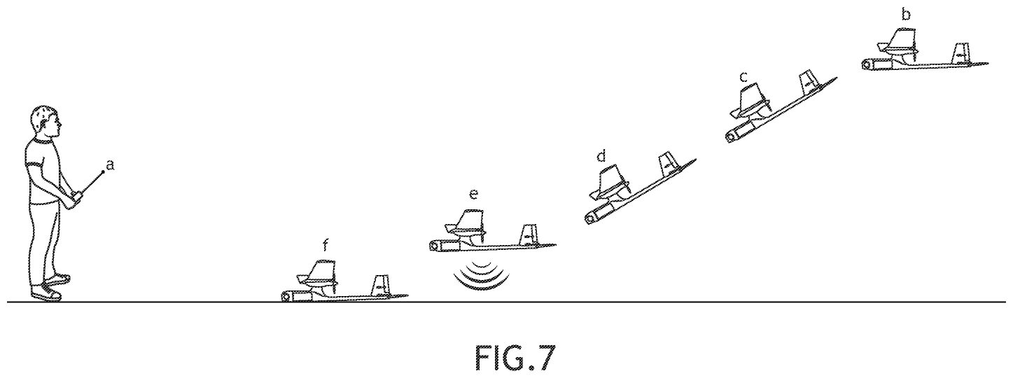

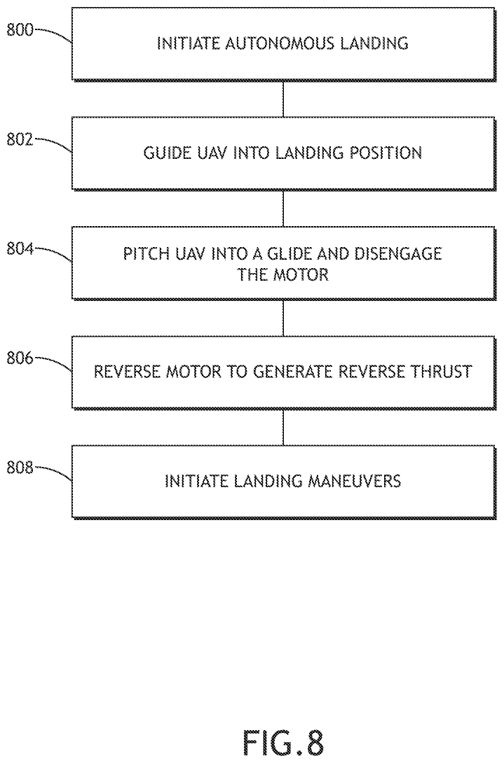

Referring to FIGS. 7 and 8, a block environmental view illustrating a process for automatic landing according to an exemplary embodiment of the present disclosure, and a corresponding flowchart, are shown. State of the art Class 1 and Class 2 UAVs often operate in restricted spaces such as small clearings within forests, making traditional aircraft landings difficult or impossible. Existing solutions include performing a full-stall landing where the UAV approaches the landing zone on an operator specified “final approach” vector, then actuates the elevator to put the UAV into a stalled state, reducing forward velocity and increasing drag. The UAV carries the steep angle of descent and rapidly descends at near terminal velocity to the ground; at the final seconds of approach, the nose tips and the UAV belly-flops onto the ground which often damages components of the UAV.

In at least one embodiment, a UAV operator initiates 800 an autonomous landing such as via a control signal. An onboard processor guides 802 the UAV into a landing position or orientation based on altitude. The UAV then pitches 804 into a glide angle and disengages the motor. The glide angle may be predetermined or dynamically determined based on environmental factors including airspeed and windspeed. When the UAV determines that it is at a specified altitude, the motor is reversed 806 to generate reverse thrust to further reduce the airspeed and glide distance. The UAV then initiates 808 landing procedures and a second, lower predetermined altitude. Landing procedures may include coming out of the descent angle for a controlled landing.

In one exemplary embodiment, the UAV operator uses a ground control station to initiate 800 an autonomous landing. The UAV autopilot initiates the landing by bringing 802 the aircraft into position to land at the location designated either by the operator or an internal algorithm. On approach, the UAV pitches 804 into a glide at a predetermined angle, shuts off the motor and begins decent. At a predetermined altitude, the autopilot reverses 806 the motor generating reverse thrust using the propeller to decrease air speed. At a lower predetermined altitude, the UAV comes out of its glide and begins final approach for a short distance landing.

In at least one embodiment, the UAV may initiate 800 an autonomous landing based on certain predefined conditions within the UAV such as low battery voltage, sensor failures, after completing all pre-set waypoints, or lack of communication for a pre-set amount of time with a ground control station. Furthermore, the UAV may identify an initial launch or home point established at startup as the designated landing location.

It is believed that the inventive concepts disclosed herein and many of their attendant advantages will be understood by the foregoing description of embodiments of the inventive concepts disclosed, and it will be apparent that various changes may be made in the form, construction, and arrangement of the components thereof without departing from the broad scope of the inventive concepts disclosed herein or without sacrificing all of their material advantages; and individual features from various embodiments may be combined to arrive at other embodiments. The form herein before described being merely an explanatory embodiment thereof, it is the intention of the following claims to encompass and include such changes. Furthermore, any of the features disclosed in relation to any of the individual embodiments may be incorporated into any other embodiment.

What is claimed is:

1. An unmanned aerial vehicle (UAV) comprising:
a fuselage;
a motor configured to drive a propeller; and
a wing,
wherein:
the propeller is disposed above the fuselage on a pylon;
the wing is disposed on the pylon; and
the propeller is disposed sufficiently above the fuselage to avoid turbulence generated by the fuselage.

2. The UAV of claim 1, further comprising:
a plurality of control surfaces disposed in the wing;
at least one processor configured to control the plurality of control surfaces; and
a memory connected to the at least one processor for embodying processor executable code to configure the at least one processor to:
receive a signal to place the UAV into an automatic launch mode;
execute a climb process via manipulation of the plurality of control surfaces until a predetermined altitude is reached;
execute a loiter process to maintain the UAV within a predetermined radius without any operator control inputs; and
disengage the loiter process when an operator control signal is received.

3. The UAV of claim 2, wherein the at least one processor is further configured to:
receive a signal to place the UAV into an automatic landing mode;
place the UAV into a landing orientation based on altitude;
pitch the UAV into a glide;
disengage the motor;
reverse the motor to generate reverse thrust at a predetermined altitude; and
initiate a set of landing maneuvers.

4. The UAV of claim 2, further comprising:
at least one airspeed sensor connected to the at least one processor; and
at least one distance sensor connected to the at least one processor,
wherein the at least one processor is further configured to:
receive airspeed data from the at least one airspeed sensor;
receive distance values from the at least one distance sensor; and
execute a feedback loop during the loiter process based on the airspeed data and distance values.

5. The UAV of claim 4, wherein the at least one distance sensor comprises:
a lidar configured to produce distance values below fifteen meters;
a barometer configured to produce distance values above fifteen meters; and
a GPS receiver.

6. The UAV of claim 4, wherein the at least one distance sensor comprises a camera configured to determine distance values via object recognition algorithms.

7. The UAV of claim 1, wherein the propeller is disposed to create a gap between the propeller and a posterior edge of the wing, the gap defined by a predefined threshold of engagement with turbulent air from the wing.

8. An unmanned aerial vehicle (UAV) comprising:
a fuselage;
a wing comprising a plurality of control surfaces;
a motor configured to drive a propeller;
at least one processor; and
a memory connected to the at least one processor for embodying processor executable code to configure the at least one processor to:
receive a signal to place the UAV into an automatic launch mode;
execute a climb process via manipulation of the plurality of control surfaces until a predetermined altitude is reached;
execute a loiter process to maintain the UAV within a predetermined radius without any operator control inputs; and
disengage the loiter process when an operator control signal is received.

9. The UAV of claim 8, wherein the at least one processor is further configured to maintain the UAV at a predetermined altitude.

10. The UAV of claim 8, wherein the at least one processor is further configured to:
receive a signal to place the UAV into an automatic landing mode;
place the UAV into a landing orientation based on altitude;
pitch the UAV into a glide;
disengage the motor;
reverse the motor to generate reverse thrust at a predetermined altitude; and
initiate a set of landing maneuvers.

11. The UAV of claim 10, further comprising:
at least one airspeed sensor connected to the at least one processor; and
at least one distance sensor connected to the at least one processor,
wherein the at least one processor is further configured to:
receive airspeed data from the at least one airspeed sensor;
receive distance values from the at least one distance sensor; and
execute a feedback loop during the loiter process based on the airspeed data and distance values.

12. The UAV of claim 11, wherein the at least one distance sensor comprises:
a lidar configured to produce distance values below fifteen meters;
a barometer configured to produce distance values above fifteen meters; and
a GPS receiver.

13. The UAV of claim 11, wherein the at least one distance sensor comprises a camera configured to determine distance values via object recognition algorithms.

14. The UAV of claim 8, wherein:
the propeller is disposed sufficiently above the fuselage to avoid turbulence generated by the fuselage; and
the propeller is disposed to create a gap between the propeller and a posterior edge of the wing, the gap defined by a predefined threshold of engagement with turbulent air from the wing.

15. An unmanned aerial vehicle (UAV) comprising:
a fuselage;
a wing comprising a plurality of control surfaces;
a motor configured to drive a propeller;
at least one processor; and
a memory connected to the at least one processor for embodying processor executable code to configure the at least one processor to:
receive a signal to place the UAV into an automatic landing mode;
place the UAV into a landing orientation based on altitude;
pitch the UAV into a glide;
disengage the motor;
reverse the motor to generate reverse thrust at a predetermined altitude; and
initiate a set of landing maneuvers.

16. The UAV of claim 15, wherein the at least one processor is further configured to:
receive a signal to place the UAV into an automatic launch mode;
execute a climb process via manipulation of the plurality of control surfaces until a predetermined altitude is reached;
execute a loiter process to maintain the UAV within a predetermined radius without any operator control inputs; and
disengage the loiter process when an operator control signal is received.

17. The UAV of claim 16, further comprising:
at least one airspeed sensor connected to the at least one processor; and
at least one distance sensor connected to the at least one processor,
wherein the at least one processor is further configured to:
receive airspeed data from the at least one airspeed sensor;
receive distance values from the at least one distance sensor; and
execute a feedback loop during the loiter process based on the airspeed data and distance values.

18. The UAV of claim 17, wherein the at least one distance sensor comprises:
a lidar configured to produce distance values below fifteen meters;
a barometer configured to produce distance values above fifteen meters; and
a GPS receiver.

19. The UAV of claim 17, wherein the at least one distance sensor comprises a camera configured to determine distance values via object recognition algorithms.

20. The UAV of claim 15, wherein:
the propeller is disposed sufficiently above the fuselage to avoid turbulence generated by the fuselage; and
the propeller is disposed to create a gap between the propeller and a posterior edge of the wing, the gap defined by a predefined threshold of engagement with turbulent air from the wing.
